(19) United States
(12) Patent Application Publication
(10) Pub. No.: US 2022/0165079 A1
(43) Pub. Date: May 26, 2022

(54) ELECTRONIC APPARATUS HAVING FINGERPRINT SENSING FUNCTION

(71) Applicant: EGIS TECHNOLOGY INC., Hsinchu City (TW)

(72) Inventors: Chung-Yi Wang, Hsinchu City (TW); Yu-Hsuan Lin, Hsinchu City (TW); Chih-Hsiang Chuang, Hsinchu City (TW)

(73) Assignee: Egis Technology Inc., Hsinchu City (TW)

(21) Appl. No.: 17/601,441

(22) PCT Filed: Feb. 24, 2020
(86) PCT No.: PCT/CN2020/076353

§ 371 Date: Oct. 5, 2021

Related U.S. Application Data
(60) Provisional application No. 62/842,538, filed on May 3, 2019.
(60) Provisional application No. 62/853,720, filed on May 29, 2019.

(51) Int. Cl. G06V 40/13; G06V 10/147; G06F 3/041

(52) U.S. Cl. CPC G06V 40/13; G06F 3/04164; G06V 10/147

(57) ABSTRACT

An electronic apparatus having a fingerprint sensing function, including a touch panel, a driving circuit, a fingerprint sensing array, and a fingerprint sensing circuit, is provided. The driving circuit provides a driving signal to the touch panel. The fingerprint sensing array includes multiple sensing units arranged in an array. The fingerprint sensing circuit is coupled to the sensing units on the fingerprint sensing array via multiple sensing data lines, and applies multiple control signals to the sensing units via the sensing data lines. A working frequency of the driving signal is the same as a working frequency of the control signals, and the driving signal is synchronized with the control signals.

### BACKGROUND

### Technical Field

This disclosure relates to a fingerprint sensing technology, and in particular to an electronic apparatus having a fingerprint sensing function.

### Description of Related Art

With the development of touch technologies and display technologies, touch display devices are been favored by more users. A user may directly operate a touch device with a finger or a stylus, and the operation manner is intuitive and very convenient. Currently, the touch display devices have been widely applied to various types of electronic products, such as smart phones, tablet computers, or portable notebook computers. On the other hand, fingerprint recognition technologies are gradually been widely applied to various electronic apparatus or products, which at least includes fingerprint recognition technologies that are being continuously developed and improved such as capacitive, optical, and ultrasonic.

With an increase in size of the touch screen of the mobile electronic apparatus, the space left for a fingerprint sensing component beneath a non-display region is gradually being limited. In this case, in order to provide a more convenient user experience, a proposal of under-screen fingerprint recognition by disposing the fingerprint sensing component beneath the touch screen has been gaining importance. If the electronic apparatus has an under-screen fingerprint recognition function, the user may perform a touch operation and a fingerprint recognition operation on a touch display region concurrently. However, in order to realize the under-screen fingerprint recognition function, components and traces required by a fingerprint sensing module have to be configured above a touch sensing electrode or on the same plane as the touch sensing electrode. Therefore, power lines between the touch sensing electrodes are interfered by an electrically conductive object (such as a metal trace or a fingerprint sensing electrode) of the fingerprint sensing module when the fingerprint sensing module is in operation, thereby affecting the touch quality. For example, a coupling capacitance is generated between the electrically conductive object of the fingerprint sensing module and the touch sensing electrode, so that it is more difficult to detect a small capacitance value change due to a finger touch. Therefore, how to integrate the components required for the touch function and the fingerprint recognition function to realize a good touch performance and fingerprint recognition performance remains a challenge for those skilled in the art.

### SUMMARY

This disclosure provides an electronic apparatus having a fingerprint sensing function, which can lower undesirable interference by a fingerprint sensing component on touch quality, so as to improve the touch quality.

An embodiment of the disclosure provides an electronic apparatus, which includes a touch panel, a driving circuit, a fingerprint sensing array, and a fingerprint sensing circuit. The driving circuit provides a driving signal to the touch panel. The fingerprint sensing array includes multiple sensing units arranged in an array. The fingerprint sensing circuit is coupled to the sensing units on the fingerprint sensing array via multiple sensing data lines, and applies multiple control signals to the sensing units via the sensing data lines. A working frequency of the driving signal is the same as a working frequency of the control signal, and the driving signal is synchronized with the control signal.

Based on the above, in the embodiment of the disclosure, the fingerprint sensing circuit may apply the multiple control signals to the sensing data lines, and the control signals are of the same frequency and are in synchronization with the driving signal provided by the driving circuit to the touch panel. In this way, the coupled interference caused by the fingerprint sensing component on the touch sensing electrode can be reduced, thereby lowering the undesirable impact of the fingerprint sensing component on touch detection.

To make the abovementioned more comprehensible, several embodiments accompanied by drawings are described in detail as follows.

### BRIEF DESCRIPTION OF THE DRAWINGS

The accompanying drawings are included for further understanding of the disclosure, and the drawings are incorporated into this specification and constitute a part of this specification. The drawings illustrate the embodiments of the disclosure, and together with the descriptions serve to explain the principles of the disclosure.

FIG. 1 is a schematic diagram of an electronic apparatus according to an embodiment of the disclosure.

FIG. 2 is a schematic diagram of an electronic apparatus according to an embodiment of the disclosure.

FIG. 3 is a signal timing diagram of the control signal and the driving signal according to the embodiment in FIG. 2.

FIG. 4 is a schematic diagram of an electronic apparatus according to an embodiment of the disclosure.

FIG. 5 is a signal timing diagram of the control signal and the driving signal according to the embodiment in FIG. 4.

FIG. 6 is a schematic diagram of an electronic apparatus according to an embodiment of the disclosure.

FIG. 7 is a signal timing diagram of the control signal and the driving signal according to the embodiment in FIG. 6.

### DESCRIPTION OF REFERENCE SIGNS OF THE ACCOMPANYING DRAWINGS

10: Electronic apparatus
110: Touch panel
120: Driving circuit
130: Fingerprint sensing array
140: Fingerprint sensing circuit
150: Power supply circuit
130 (1,1) to 130 (M,N): Fingerprint sensing unit
L_1 to L_N: Sensing data line
Sd: Driving signal
X1: Control signal
E1: Touch sensing electrode
D_1 to D_R: Driving scan line
Tcon: Timing control signal
TD_1: Touch sensing period
FD_1: Fingerprint sensing period
X2: Fingerprint sensing signal
P1: Power signal
M1: Notification signal
Vx: Power signal
140_1: Reading circuit
OP1: Operational amplifier
AVDD: Reference voltage
Yl: Notification signal
140_2: Signal generation circuit

### DESCRIPTION OF THE EMBODIMENTS

Reference will now be made in detail to exemplary embodiments of the disclosure, and examples of the exemplary embodiments are illustrated in the accompanying drawings. Whenever possible, the same reference numerals are used in the drawings and descriptions to indicate the same or similar parts.

It should be understood that when a component such as a layer, film, region, or substrate is referred to as being “on” or “connected” to another component, it may be directly on or connected to the other component, or there may be intermediate components in-between. In contrast, when a component is referred to as being “directly on” or “directly connected to” another component, there are no intermediate components. As used herein, “connected” may refer to a physical and/or an electrical connection. Furthermore, “electrically connected to” or “coupled to” may mean that there are other components between the two components.

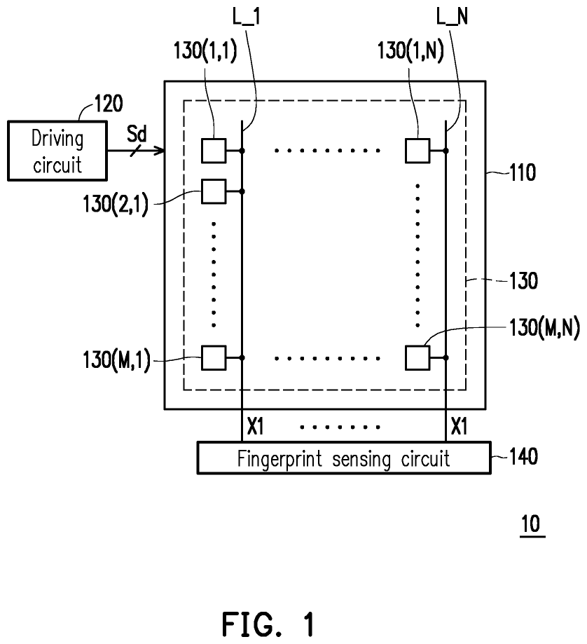

FIG. 1 is a schematic diagram of an electronic apparatus according to an embodiment of the disclosure. With reference to FIG. 1, an electronic apparatus 10 having a fingerprint sensing function may be implemented as a smart phone, a panel, a game console, or other electronic products having a under-screen fingerprint recognition function, and is not limited by the disclosure. The electronic apparatus 10 includes a touch panel 110, a driving circuit 120, a fingerprint sensing array 130, and a fingerprint sensing circuit 140.

In the embodiment of the disclosure, the touch panel 110 may be implemented as a touch display panel, and a display region of the touch display panel is a touchable region. A user may perform a touch operation by touching the display region on the electronic apparatus 10 with a finger or other touch objects. In addition, the user may also perform a fingerprint recognition operation by touching the display region on the electronic apparatus 10 with a finger. The touch panel 110 may be implemented as a touchable display panel including an organic light-emitting diode (OLED) display panel, an active-matrix organic light-emitting diode (AMOLED) display panel, or a liquid crystal display (LCD) display panel, and is not limited by the disclosure.

The driving circuit 120 is coupled to the touch panel 110, and is configured to control an operation of the touch panel 110. The driving circuit 120 is, for example, a touch display driver IC (TDDI), a timing controller, or other similar circuits.

The fingerprint sensing array 130 includes multiple fingerprint sensing units 130 (1,1), . . . ,130 (M,1), . . . ,130 (1,N), . . . , and 130 (M,N) arranged in an array, where M and N may be any integers determined according to design requirements. In an embodiment of the disclosure, the electronic apparatus 10 may use the capacitive fingerprint recognition technology. Correspondingly, the fingerprint sensing units 130 (1, 1) to 130 (M, N) may be implemented as multiple fingerprint sensing electrodes. In other words, each of the fingerprint sensing units 130 (1, 1) to 130 (M, N) may include the fingerprint sensing electrodes, so as to sense ridges and furrows of a fingerprint according to a capacitance change of the fingerprint sensing electrodes. In other words, by charging and discharging the fingerprint sensing electrodes, the fingerprint sensing array 110 may sense the capacitance change caused by the ridges and the furrows of the fingerprint of the finger to generate a fingerprint image. Alternatively, in another embodiment, the electronic apparatus 10 may use the optical fingerprint recognition technology, and correspondingly, each of the fingerprint sensing units 130 (1, 1) to 130 (M, N) may include photodiodes. In other words, each of the fingerprint sensing units 130 (1, 1) to 130 (M, N) may include the photodiode that is configured to perform photoelectric conversion, so as to perform fingerprint sensing according to a fingerprint light reflected by the finger. In other words, by illuminating a finger through a self-luminous display panel or an additional illumination component, the fingerprint sensing array 130 may sense a reflected light that is reflected by the finger and has fingerprint information, so as to generate a fingerprint image.

The fingerprint sensing circuit 140 is coupled to the sensing units 130 (1, 1) to 130 (M, N) on the fingerprint sensing array 130 via multiple sensing data lines L_1 to L_N. In detail, the sensing data lines L_1 to L_N are each coupled to a column of fingerprint sensing units of the fingerprint sensing array 130. For example, the sensing data line L_1 is electrically connected to a first column of fingerprint sensing units 130 (1, 1), 130 (2, 1), . . . , and 130 (M, 1), and the remaining sensing data lines may be deduced by analogy. In addition, the fingerprint sensing circuit 140 is coupled to the sensing data lines L_1 to L_N, so as to receive fingerprint sensing signals outputted by the sensing data lines L_1 to L_N during a fingerprint sensing period.

On the other hand, the touch panel 110 is a capacitive touch panel, and multiple touch sensing electrodes (not shown in FIG. 1) arranged in an array are disposed on the touch panel 110. The driving circuit 120 may provide a driving signal Sd to the touch panel 110, so as to drive each of the touch sensing electrodes to perform touch sensing. Based on this, a touch position of a finger of a user may be determined by detecting a capacitance change on the touch sensing electrodes.

It should be noted that in the embodiment of the disclosure, in order to reduce impact of coupled interference by the fingerprint sensing units 130 (1,1) to 130 (M,N) and the sensing data lines L_1 to L_N on the touch sensing electrodes on the touch panel 110, the sensing data lines L_1 to L_N have multiple control signals X1 applied to the sensing units 130 (1,1), 130 (2,1), . . . , and 130 (M,N). A working frequency of the driving signal Sd is the same as a working frequency of the control signals X1, and the driving signal Sd is synchronized with the control signals X1. In addition, amplitudes of the control signals X1 are the same, which is a fixed value that may be configured according to actual requirements. In general, the driving signal Sd is a driving pulse having a specific working frequency, and its frequency range may be, for example, 10 KHz to 300 KHz. Correspondingly, a signal waveform of the control signals X1 on the sensing data lines L_1 to L_N is the same as a signal waveform of the driving signal Sd. To be more specific, when the driving signal Sd transitions from a low level to a high level, the control signals X1 on the sensing data lines L_1 to L_N also transition from a low level to a high level synchronously. When the driving signal Sd transitions from the high level to the low level, the control signals X1 on the sensing data lines L_1 to L_N also transition from the high level to the low level synchronously. In this way, when the touch panel 110 is performing touch sensing, potential changes of the fingerprint sensing units 130 (1,1), 130 (2,1), . . . , and 130 (M,1), and the sensing data lines L_1 to L_N are synchronized with a potential change of the driving signal Sd, therefore a coupling effect caused by the fingerprint sensing units 130 (1,1), 130 (2,1), . . . , and 130 (M,1), and the sensing data line L_1 to L_N may be ignored to facilitate accurate detection of a tiny capacitance due to a finger touch.

It should be noted that, in an implementation, the electronic apparatus 10 alternately operates between the fingerprint sensing period and a touch sensing period. When the electronic apparatus 10 is operating in the fingerprint sensing period, the sensing data lines L_1 to L_N are configured to sequentially output sensing results of the fingerprint sensing units 130 (1, 1) to 130 (M, N) to the fingerprint sensing circuit 140. When the electronic apparatus 10 is operating in the touch sensing period, the sensing data lines L_1 to L_N have the control signals X1, which have the same frequency and are in synchronization with the driving signal Sd.

The following examples are listed respectively to illustrate how to enable the sensing data lines L_1 to L_N to have the control signals X1 that have the same frequency and are in synchronization with the driving signal Sd.

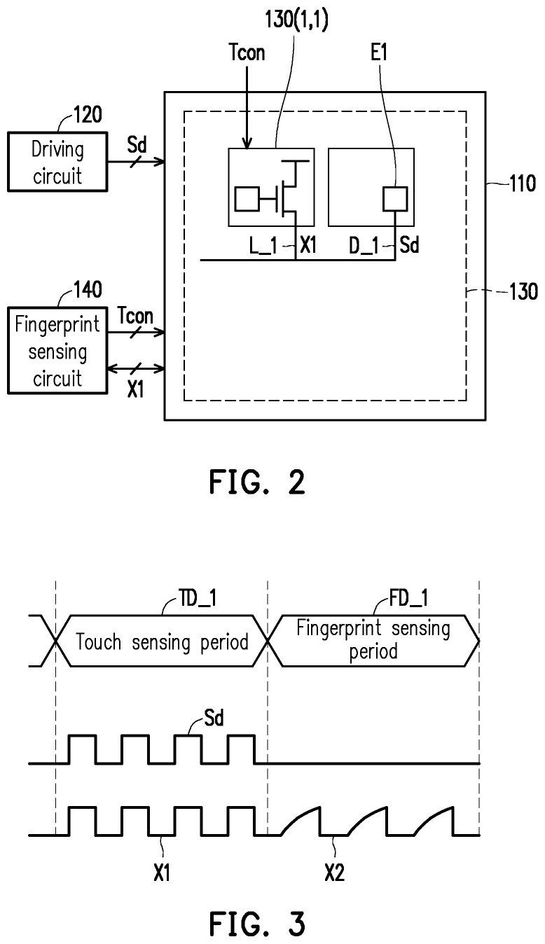

FIG. 2 is a schematic diagram of an electronic apparatus according to an embodiment of the disclosure. FIG. 3 is a signal timing diagram of the control signal and the driving signal according to the embodiment in FIG. 2. With reference to FIG. 2 first, multiple driving scan lines (for example, a driving scan line D_1) are configured on the touch panel 110, which are configured to transmit the driving signal Sd to each of the touch sensing electrodes (for example, a touch sensing electrode E1). In the embodiment, the multiple driving scan lines on the touch panel 110, which are configured to transmit the driving signal Sd, may be connected to the corresponding sensing data lines L_1 to L_N, so that the working frequency of the driving signal Sd provided by the driving circuit 120 is the same as the working frequencies of the control signals X1 on the data lines L_1 to L_N. In other words, in the embodiment, the sensing data lines L_1 to L_N have the control signals X1 that have a same wave signal waveform as that of the driving signal Sd in response to the driving signal Sd outputted by the driving circuit 120.

For convenience of description, only one of the driving scan lines D_1, one touch sensing electrode E1, one of the sensing data lines L_1, and one of the touch sensing electrodes E1 are shown in FIG. 2. Reference may be made for detailed operations of the remaining repetitive components, which are not repeated here. As shown in FIG. 2, since the sensing data line L_1 connected to the fingerprint sensing unit 130 (1,1) is joined to the driving scan line D_1 of the touch sensing electrode E1, during the touch sensing period, the signal waveform of the control signals X1 on the sensing data line L_1 is the same as the signal waveform of the driving signal Sd on the driving scan line D_1. In other words, electric field induction effects of the control signals X1 and the driving signal Sd are consistent, which do not damage the electric field, thereby improving touch quality. During the fingerprint sensing period, the fingerprint sensing unit 130 (1, 1) outputs the fingerprint sensing signal to the fingerprint sensing circuit 140 through the sensing data line L_1. In the embodiment, the fingerprint sensing circuit 140 may control the fingerprint sensing unit 130 (1, 1) to enable or disable the fingerprint sensing operation through a timing control signal Tcon.

With reference to FIG. 3, in a touch sensing period TD_1, the driving circuit 120 outputs the driving signal Sd having a specific working frequency to the touch panel 110, so as to drive the touch sensing electrode E1 to perform a touch sensing operation. Correspondingly, since the sensing data line L_1 is connected to the driving scan line D_1, during the touch sensing period TD_1, the sensing data line L_1 responds to the outputted driving signal Sd and has the control signal X1 that has the same frequency. Then, in a fingerprint sensing period FD_1, the driving circuit 120 stops outputting the driving signal Sd to drive the touch panel 110, but the fingerprint sensing unit 130 (1, 1) responds to the fingerprint sensing operation being enabled by the timing control signal Tcon and enables the sensing data line L_1 to output a fingerprint sensing signal X2 to the fingerprint sensing circuit 140.

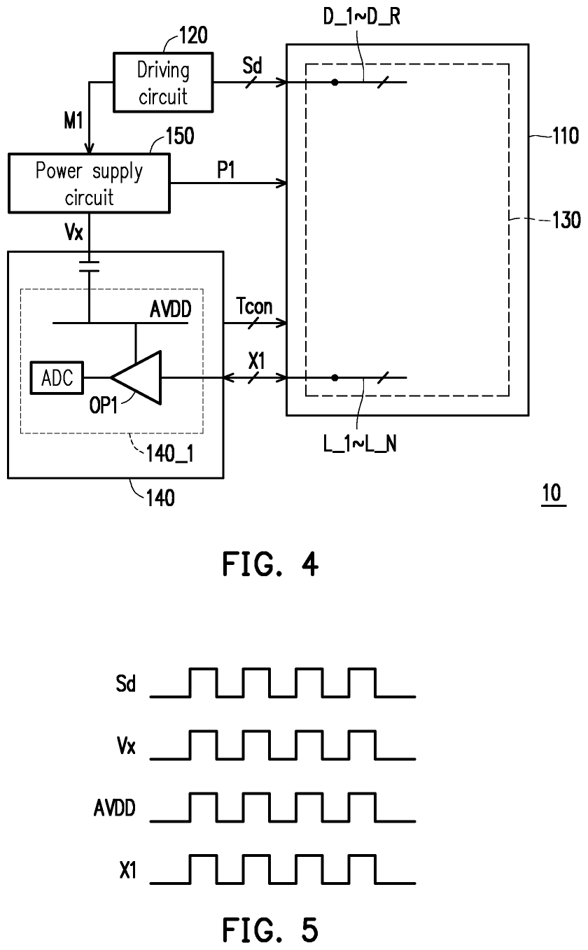

FIG. 4 is a schematic diagram of an electronic apparatus according to an embodiment of the disclosure. FIG. 5 is a signal timing diagram of the control signal and the driving signal according to the embodiment in FIG. 4. In the embodiment, the fingerprint sensing circuit 10 further includes a power supply circuit 150. The power supply circuit 150 may be implemented, for example, as a power supply IC, so as to supply a power signal P1 to the touch panel 110. In addition, the power supply circuit 150 is coupled to the fingerprint sensing circuit 140, and provides a power signal Vx to the fingerprint sensing circuit 140. The driving circuit 120 may provide the driving signal Sd to the driving scan lines D_1 to D_R that are configured to drive the touch sensing electrodes. The fingerprint sensing circuit 140 includes multiple reading circuits respectively connected to the sensing data lines L_1 to L_N, so as to convert capacitance sensing results of the fingerprint sensing units 130 (1, 1) to 130 (M, N) into digital data. For the convenience of description, a reading circuit 140_1 is taken as an example for illustration. The reading circuit 140_1 includes an operational amplifier OP1 and an analog-digital converter ADC.

In the embodiment, the power signal Vx provided by the power supply circuit 150 to the fingerprint sensing circuit 140 is a pulse signal, and a pulse frequency of the power signal Vx is the same as the working frequency of the driving signal Sd, so that the working frequency of the driving signal Sd is the same as the working frequency of the control signal X1. In detail, the power supply circuit 150 may be coupled to the driving circuit 120, and the driving circuit 120 provides the working frequency of the driving signal Sd to the power supply circuit 150 through a notification signal M1. Therefore, the power supply circuit 150 may generate the synchronized power signal Vx having the same frequency to the fingerprint sensing circuit 140 according to the working frequency of the driving signal Sd. A reference voltage AVDD of the reading circuit 140_1 in the fingerprint sensing circuit 140 is also presented as a pulse signal having the same frequency in response to the power signal Vx. Based on this, since a potential of an input terminal of the operational amplifier OP1 driven by the reference voltage AVDD increases and decreases in response to periodic changes of the reference voltage AVDD, the potential of the fingerprint sensing unit connected to the operational amplifier OP1 also periodically increases and decreases. In other words, since the power signal Vx provided to the fingerprint sensing circuit 140 periodically transitions between a high level and a low level, an internal signal of the fingerprint sensing circuit 140 also periodically transitions between the high level and the low level correspondingly. Based on this, in response to the power signal Vx being a pulse signal having the same frequency as the driving signal Sd, the sensing data lines L_1 to L_N have the control signals X1, which have the same frequency as the driving signal Sd.

With reference to FIG. 5, since the power supply circuit 150 outputs the power signal Vx having the same frequency as the driving signal Sd according to the frequency of the driving signal Sd, the reference voltage AVDD and the control signals X1 on the sensing data lines L_1 to L_N also have the same frequency and are in synchronization with the driving signal Sd.

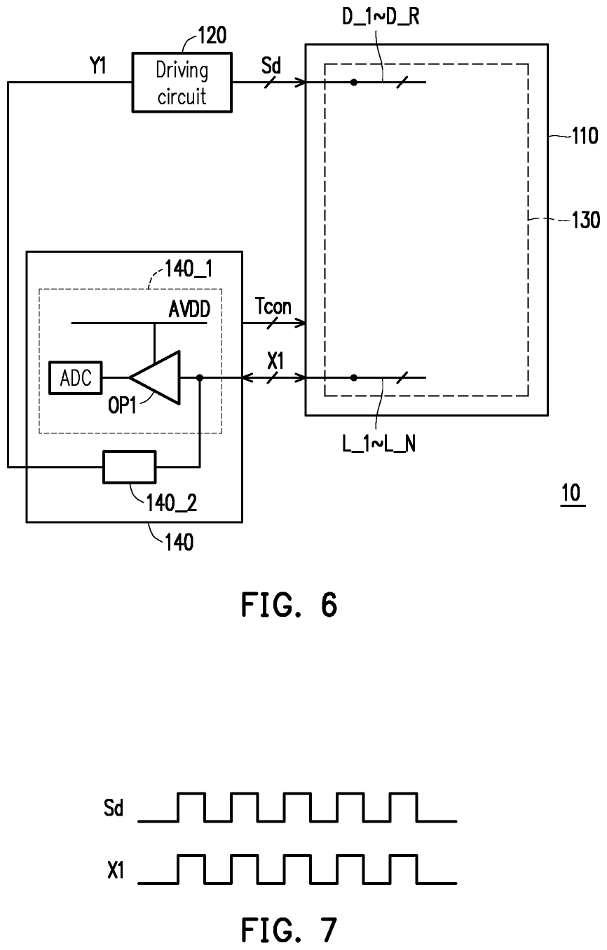

FIG. 6 is a schematic diagram of an electronic apparatus according to an embodiment of the disclosure. FIG. 7 is a signal timing diagram of the control signal and the driving signal according to the embodiment in FIG. 6. In the embodiment, the driving circuit 120 may provide the driving signal Sd to the driving scan lines D_1 to D_R that are configured to drive the touch sensing electrodes. The fingerprint sensing circuit 140 includes the multiple reading circuits respectively connected to the sensing data lines L_1 to L_N, so as to convert the capacitance sensing results of the fingerprint sensing units 130 (1, 1) to 130 (M, N) into digital data. The driving circuit 120 may be coupled to the multiple reading circuits in the fingerprint sensing circuit 140. For the convenience of description, the reading circuit 140_1 is taken as an example for description. The reading circuit 140_1 includes the operational amplifier OP1 and the analog-digital converter ADC.

In the embodiment, the driving circuit 120 may be connected to the input terminal of the operational amplifier OP1 via a signal generation circuit 140_2. For example, in response to the driving circuit 120 outputting the driving signal Sd, the driving circuit 120 may control the signal generation circuit 140_2 to generate the control signal X1 having the same frequency and in synchronization with the driving signal Sd through the notification signal Yl, so that the reading circuit 140_1 in the fingerprint sensing circuit 140 provides the control signal X1 having the same frequency and in synchronization with the driving signal Sd via one of the sensing data lines L_1 to L_N, so as to enable a voltage change frequency of one column of the fingerprint sensing units is the same as the working frequency of the driving signal Sd. Therefore, in response to the driving circuit 120 outputting the driving signal Sd, the driving circuit 120 may drive the fingerprint sensing circuit 140 to output the control signal X1 via the sensing data lines L_1 to L_N. As shown in FIG. 7, the working frequency of the driving signal Sd is the same as the working frequency of the control signals X1 on the sensing data lines L_1 to L_N, which are synchronized with each other. It can be seen that detailed operations of other repetitive components may be deduced by analogy with reference to the above description, and are not repeated here.

In summary, in the embodiments of the disclosure, during the touch sensing period, the coupled interference caused by the fingerprint sensing unit or/and the sensing data lines on the touch sensing electrode can be reduced through enabling the sensing data lines connected to the fingerprint sensing unit to have the control signals having the same working frequency as the driving signal. In this way, in the case of under-screen fingerprint sensing, the undesirable impact due to the fingerprint sensing unit being adjacent to the touch sensing electrode or/and the sensing data lines can be reduced, thereby improving the touch quality.

Finally, it should be noted that the above embodiments are only illustrations of the technical solutions of the disclosure, and are not meant to limit the disclosure. Although the disclosure has been described in detail with reference to the foregoing embodiments, those of ordinary skill in the art should understand that modifications may be made to the technical solutions described in the foregoing embodiments, or equivalent replacements of some or all of the technical features may be done, however, these modifications or replacements do not cause the essence of the corresponding technical solutions to deviate from the scope of the technical solutions according to the embodiments of the disclosure.

What is claimed is:

1. An electronic apparatus, comprising:
a touch panel;
a driving circuit, providing a driving signal to the touch panel;
a fingerprint sensing array, comprising a plurality of fingerprint sensing units arranged in an array;
a fingerprint sensing circuit, coupled to the plurality of fingerprint sensing units on the fingerprint sensing array via a plurality of sensing data lines, wherein the plurality of sensing data lines applies a plurality of control signals to the plurality of fingerprint sensing units, a working frequency of the driving signal is same as a working frequency of the plurality of control signals, and the driving signal is synchronized with the plurality of control signals.

2. The electronic apparatus according to claim 1, wherein a plurality of driving scan lines of the touch panel are connected to the plurality of sensing data lines, so that the working frequency of the driving signal is the same as the working frequency of the plurality of control signals.

3. The electronic apparatus according to claim 1, further comprising:
a power supply circuit, coupled to the fingerprint sensing circuit to provide a power signal to the fingerprint sensing circuit, wherein a pulse frequency of the power signal is same as the working frequency of the driving signal, so that the working frequency of the driving signal is the same as the working frequency of the plurality of control signals.

4. The electronic apparatus according to claim 3, wherein the power supply circuit is coupled to the driving circuit, and the driving circuit provides the working frequency of the driving signal to the power supply circuit through a notification signal.

5. The electronic apparatus according to claim 1, wherein the driving circuit is coupled to the fingerprint sensing circuit, and the fingerprint sensing circuit is driven by the driving signal to output the plurality of control signals via the plurality of sensing data lines.

6. The electronic apparatus according to claim 1, wherein amplitudes of the plurality of control signals are the same.

7. The electronic apparatus according to claim 1, wherein the fingerprint sensing unit is a plurality of fingerprint sensing electrodes.
